(19) United States
(12) Patent Application Publication
(10) Pub. No.: US 2006/0025509 A1
(43) Pub. Date: Feb. 2, 2006

(54) Fluxing no-flow underfill composition containing benzoxazines

(76) Inventors: Ruzhi Zhang, Somerset, NJ (US); Osama M. Musa, Hillsborough, NJ (US); Mark Bonneau, Brea, CA (US)

Correspondence Address: Jane E. Gennaro;National Starch and Chemical, 10 Finderne Avenue, Bridgewater, NJ, 08807, US

(21) Appl. No.: 10/902,555

(22) Filed: Jul. 29, 2004

(51) Int. Cl. C08K 5/09

(52) U.S. Cl. 524/284

(57) ABSTRACT

Benzoxazine compounds can be cured with epoxies and fluxing agents to afford thermoset materials with particular utility as no-flow underfilling encapsulants within the semiconductor packaging industry.

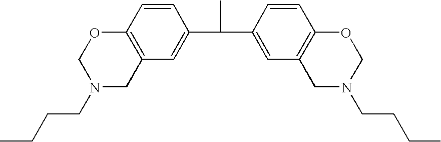

### FIELD OF THE INVENTION

This invention relates to underfill encapsulant compositions containing benzoxazines, epoxies and anhydrides to protect and reinforce the interconnections between an integrated circuit (IC) chip and a substrate in a semiconductor package, or between a semiconductor component and a substrate in a microelectronic device.

### BACKGROUND OF THE INVENTION

Microelectronic devices contain integrated circuit components that are connected electrically to, and supported on, a carrier or a substrate, such as a leadframe or a printed wire board. There are a number of variations in the architecture of integrated circuit components, two of which are known throughout the industry as flip-chip and ball grid array. With these two, as with other integrated circuit components, electrical connections are made between electrical terminations on the integrated circuit component and corresponding electrical terminations on the substrate.

One method for making these connections uses polymeric or metallic solder material that is applied in bumps to the electrical terminals on either the component or the substrate. Solders are subject to oxidation and in consequence a fluxing agent is added to the component (silicon chip) or substrate. The terminals are aligned and contacted together and the resulting assembly is heated to reflow the metallic or polymeric material and solidify the connection.

A long-standing problem in this type of interconnect is the mismatch of the coefficients of thermal expansion (CTE) between the integrated circuit component, the interconnect material, and the substrate. To alleviate this mismatch and support the polymeric or metallic interconnects, encapsulant materials are filled in the interstices between the component and the substrate around the polymeric or metallic solder. These materials are known as underfills and their use enhances the fatigue life of the solder joints.

In a conventional underfill application known as capillary flow, the underfill dispensing and curing takes place after the reflow of the metallic or conductive polymeric solders and the formation of interconnection. In this procedure, before the terminals are aligned and contacted together, the fluxing agent or material is dispensed onto the terminals on the substrate. The terminals on the semiconductor chip and substrate are aligned, and the assembly is heated to reflow the solder joint. For metallic interconnects, such as eutectic or lead-free solder, this is at approximately 190° to 230° C.

At this point, a measured amount of underfill encapsulant material is dispensed along one or more peripheral sides of the electronic assembly and capillary action within the component-to-substrate gap draws the material inward. After the gap is filled, additional underfill encapsulant may be dispensed along the complete assembly periphery to help reduce stress concentrations and prolong the fatigue life of the assembled structure. The underfill encapsulant is subsequently cured to reach its optimized final properties. Currently, most encapsulated flip-chip packages are produced through this process.

A more efficient procedure is that used with a so-called no-flow fluxing underfill. In this process, the fluxing material is contained in the underfill, which is applied to the substrate prior to placement of the semiconductor component. After the component is placed, the full assembly is passed through a reflow oven, during which time the solder joints reflow and the underfill cures. The fluxing agent remains part of the cured underfill. In this process, the separate steps of applying the flux and post-curing the underfill are eliminated.

Typically, the underfill encapsulant is dispensed by syringe, which means that the viscosity must be sufficiently low for ease of dispensability. In the no-flow fluxing underfill operation, soldering and curing the underfill occur during the time in the reflow oven, which means that the underfill must maintain its low viscosity during the melting of the solder and cure rapidly after that. Currently in the industry, there is a demand for environmentally benign lead-free solders, such as, Sn/Ag with a melting point of 225° C. and Sn/Ag/Cu with a melting point of 217° C. When these materials are used, the no-flow fluxing underfills must cure at higher temperatures.

### SUMMARY OF THE INVENTION

This invention is a composition for use as a fluxing underfill that contains a benzoxazine resin, an epoxy, and a fluxing agent.

The following examples will disclose the synthesis of difunctional benzoxazine resins that are liquids at room temperature and that are suitable for use in no flow fluxing underfill compositions, compositions containing benzoxazines, and performance results. Suitable fluxing agents for these compositions include 1-naphthanoic acid, 1-naphthylacetic acid, and polysebacic polyanhydride (PSPA from Lonza). Suitable epoxy resins are commercially available and can be chosen as desired by the practitioner.

### EXAMPLE 1

### Synthesis

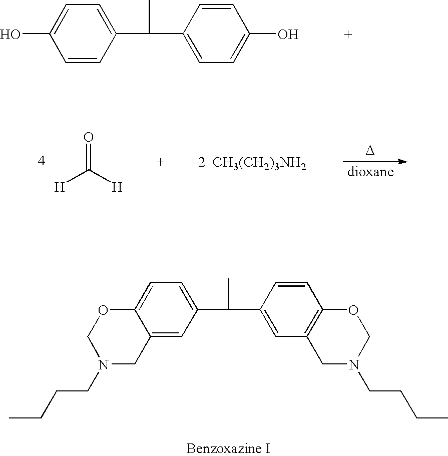

A two liter four-necked round-bottom flask equipped with an overhead mixer, condenser, addition funnel, and thermometer, was charged with 162.30 g of aqueous formaldehyde solution (37 wt % solution in water, 2.0 mol) and 400 mL of dioxane. The mixture was cooled by ice bath and the temperature was kept below 10° C. To this mixture 73.15 g of n-butylamine (1.0 mol) in 100 mL of dioxane was added dropwise. Upon completion of addition, the mixture was stirred for an additional 30 minutes. To this mixture was added 107.15 g of bisphenol E (0.5 mol) in 500 mL of dioxane. The temperature was then raised to the reflux temperature and the reaction was run overnight. After removal of solvent in vacuo, the viscous oil was dissolved in 800 mL of methyl-t-butyl ether (MTBE). The ether solution was washed with 3N aqueous sodium hydroxide solution (3×800 mL), followed by saturated sodium bicarbonate solution (3×600 mL), de-ionized water (3×800 mL), and saturated brine solution (400 mL). The organic layer was dried first over sodium sulfate and then silica gel. After removal of solvent in vacuo, 171.28 g of a yellowish liquid resin was obtained in a yield of 84%. The viscosity is 77,900 mPa.s at ambient temperature. ¹H NMR (CDCl₃, 400 MHz): δ 6.94 (d, 2H), 6.76 (s, 2H), 6.68 (d, 2H), 4.81 (s, 4H), 3.93 (s, 5H), 2.72 (t, 4H), 1.52-1.55 (m, 7H), 1.32-1.38 (m, 4H), 0.92 (t, 6H).

### Example 2

### Synthesis

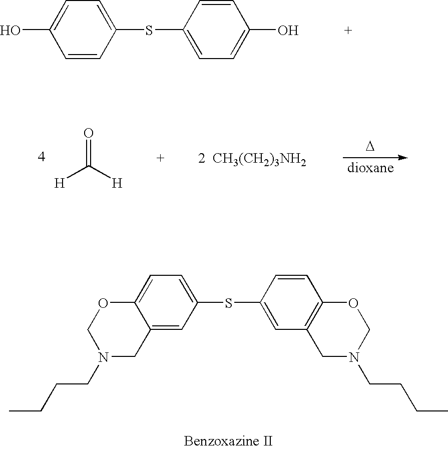

A 500 mL three-necked round-bottom flask equipped with an overhead mixer, condenser, addition funnel, and thermometer, was charged with 32.46 g of aqueous formaldehyde solution (37 wt % solution in water, 0.40 mol) and 80 mL of dioxane. The mixture was cooled by ice bath and the temperature was kept below 10° C. To this mixture 14.63 g of n-butyl-amine (0.20 mol) in 20 mL of dioxane was added dropwise. Upon completion of addition, the mixture was stirred for an additional 30 minutes. To this mixture was added 21.83 g of 4,4′-thiodiphenol (0.10 mol) in 100 mL of dioxane. The temperature was then raised to the reflux temperature and the reaction was run overnight. After removal of solvent in vacuo, the viscous oil was dissolved in 200 mL of MTBE. The ether solution was washed with 3N aqueous sodium hydroxide solution (3×200 mL), followed by saturated sodium bicarbonate solution (200 mL), de-ionized water (2×200 mL), and saturated brine solution (200 mL). The organic layer was dried first over sodium sulfate and then over silica gel. After removal of solvent in vacuo, 22.46 g of a brownish liquid resin was obtained in a yield of 54%. The viscosity is 45,300 mPa.s at ambient temperature. ¹H NMR (CDCl₃, 400 MHz): δ 7.11 (d, 2H), 6.99 (s, 2H), 6.72 (d, 2H), 4.87 (s, 4H), 3.95 (s, 4H), 2.74 (t, 4H), 1.51-1.57 (m, 4H), 1.34-1.40 (m, 4H), 0.94 (t, 6H).

### EXAMPLE 3

### Formulations

Four Compositions (A through D) were prepared to contain a benzoxazine from Example 1 or 2, a monobenzoxazine (benzoxazine IlIl or IV) as a diluent, an epoxy resin, and the anhydride PSPA as a fluxing agent.

The monobenzoxazines used had the following structures:

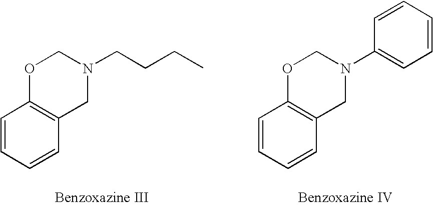

The epoxy resins used were Epiclon EXA850CRP from Dainippon Ink & Chemicals and XU71790-04L from Dow Chemical.

The fluxing agents used were 1-naphthanoic acid, 1-naphthylacetic acid, and polysebacic polyanhydride (PSPA from Lonza).

The components of the compositions were blended and passed through a three-roll mill three times at ambient temperature. The composition components are reported in parts by weight in Table 1.

TABLE 1
Composition Components

| | Ex 3 A | Ex 3 B | Ex 3 C | Ex 3 D |
|---|---|---|---|---|
| Benzoxazine I | 30 | 30 | 30 | — |
| Benzoxazine II | — | — | — | 30 |
| Monobenzoxazine III | 10 | 10 | — | — |
| Monobenzoxazine IV | — | — | 10 | 10 |
| Epoxy EXA-850CRP | 30 | 30 | 40 | 40 |
| Epoxy XU71790-04L | 10 | 10 | — | — |
| PSPA | 5 | 10 | 8 | 8 |

### EXAMPLE 4

### Performance

The Benzoxazine Compositions A through D from Example 3 were thermally cured by differential scanning calorimetry in which the cure onset temperature, cure peak temperature, and cure exotherm, were characterized using a DSC instrument (from TA Instruments, New Castle, Del.). The glass transition temperatures (Tg) and coefficients of thermal expansion (CTE1, before Tg, and CTE2, after Tg) of the compositions were measured using a Thermal Mechanical Analyzer (model TMA 2920 from TA Instruments, New Castle, Del.) on samples cured for two hours at 175° C.

To determine if the compositions were capable of fluxing solder, 0.2 grams of the composition were dispensed on a copper coupon, lead-free solder balls (Sn/Ag/Cu melting temperature 217° C.) were dropped into the composition, a glass cover slide was placed over the composition, the assembly placed on a hot-plate pre-heated to 145° C. for two minutes, then immediately transferred to another hot-plate pre-heated to 230-235° C. for two minutes. This two-step reflow closely simulates the standard NIST reflow profile for lead-free solder. Fluxing results were evaluated by visual examination of the lead-free solders on copper coupons: flowing and spreading of the solder within the benzoxazine composition indicated fluxing occurred.

The performance results are reported in Table 2.

TABLE 2

| | Ex 3 A | Ex 3 B | Ex 3 C | Ex 3 D |
|---|---|---|---|---|
| DSC onset temp (° C.) ¹ | 211 | 208 | 213 | 207 |
| DSC peak temp (° C.) ¹ | 228 | 225 | 230 | 224 |
| DSC delta H (J/g) ¹ | −232 | −139 | −227 | −187 |
| Lead-free solder flux | Yes | Yes | Yes | Yes |
| on Cu coupon | | | | |
| Tg (° C.) ² | 81.8 | 58 | 74.7 | 72 |
| CTE1 (ppm) ² | 65 | 72.8 | 67.7 | 68.4 |
| CTE2 (ppm) ² | 185 | 177 | 178 | 178 |
| Viscosity, mPa · s. 5 rpm | 7,800 | 20,900 | 20,200 | 14,000 |
| Spindle CP51 | | | | |

### EXAMPLE 5

### Comparative Formulations

Comparison compositions were prepared to contain benzoxazine, epoxy, and maleimide resins, without the inclusion of any fluxing agent. The benzoxazine was obtained from Vantico as product 97-191 and has the structure 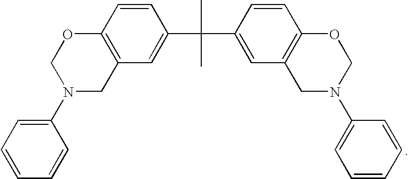
The epoxide used was a bis-A epoxide from Epiclon, product EXA850CRP. The phenolic resin used was HRJ1166 from Schenectady International. The maleimide used has the structure

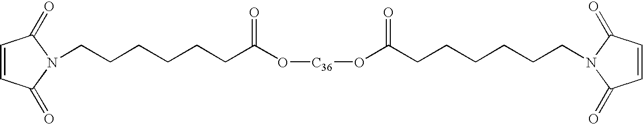

in which C₃₆ represents a linear or branched hydrocarbon chain that may contain a cyclic moiety. The composition components, given in parts by weight, and fluxing performance results are reported in Table 3.

TABLE 3
Composition Components

| | Comparative | Comparative | Comparative |
|---|---|---|---|
| | Example 1 | Example 2 | Example 3 |
| Benzoxazine Resin | 10 | 35 | 25 |
| Epoxy Resin Epiclon | 10 | 70 | |
| EXA-850CRP | | | |
| Phenolic Resin | | 35 | |
| Maleimide Resin | | | 25 |
| Lead-free solder | No | No | No |
| flux on Cu coupon | | | |

In all the compositions in Table 1, the solders collapsed easily and spread on the substrate during fluxing tests. This indicated that the resin viscosity was low enough and the curing was delayed to enable the solder spreading at typical lead-free solder interconnection temperatures. When lead-free die was attached to the OSP substrate using the aforementioned encapsulant composition containing benzoxazine, good adhesion was also observed. The glass transition temperatures of the samples, which were cured for two hours at 175° C., were in the range of 58° C. to 81.8° C. without fillers. According to TMA results, the CTE1 and CTE2 were approximately 65-72.8 ppm and 177-185 ppm, respectively, without the presence of any fillers. In contrast, the compositions in Table 3 did not flux.

When a cure profile suitable for tin-lead solder (Tm=183° C.) is desirable, a cationic catalyst can be employed in the aforementioned formulations to afford a cure peak at the desired temperature. Determination of the catalyst and amount needed can be determined without undue experimentation by the practitioner. Suitable cationic catalysts include, but are not limited to, carboxylic acid, HClO₄, BF₃, AlCl₃, AlBr₃, TiCl₄, l₂, SnCl₄, WCl₆, AlEt₂CL, PF₅VCl₄ AlEtCl₂, and BF₃Et₂O. Preferred initiators include PCl₅, PCl₃, POCl₃, TiCl₄, SbCl₅, (C₆H₅)₃C⁺(SbCl₆)⁻, metallophorphyrin compounds such as aluminum phthalocyanine chloride.

What is claimed:

1. An underfill composition comprising
a benzoxazine resin,
an epoxy, and
a fluxing agent.

2. The underfill composition of claim 1 in which the benzoxazine resin has the structure

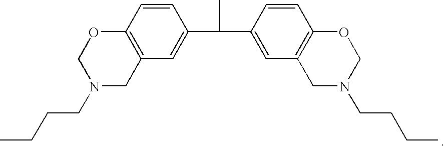

3. The underfill composition of claim 1 in which the benzoxazine resin has the structure

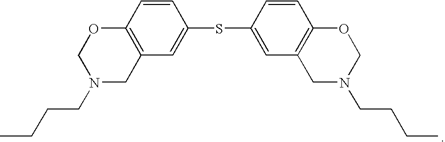

4. The underfill composition of any of the preceding claims in which the fluxing agent is 1-naphthanoic acid, 1-naphthylacetic acid, or polysebacic polyanhydride.
